(19) United States
(12) Patent Application Publication
(10) Pub. No.: US 2024/0312319 A1
(43) Pub. Date: Sep. 19, 2024

(54) Optical Connector Assembly

(71) Applicant: WINGCOMM Co. Ltd., Nantong (CN)

(72) Inventors: Yun Bai, Beijing (CN); Wei Mao, Palo Alto, CA (US); Zuodong Wang, Beijing (CN); Zhilu Yuan, Nantong (CN); Jie Ge, Suzhou (CN)

(21) Appl. No.: 18/326,529

(22) Filed: May 31, 2023

Related U.S. Application Data
(60) Provisional application No. 63/490,649, filed on Mar. 16, 2023.

(51) Int. Cl. G08B 5/36; H04B 10/25; H04B 10/40

(52) U.S. Cl. CPC G08B 5/36; H04B 10/25; H04B 10/40

(57) ABSTRACT

Optical connector assemblies are described. One aspect includes a source terminal configured to electrically and mechanically connect to an electrical signal source via a first electrical interface, a sink terminal configured to electrically and mechanically connect to an electrical signal sink via a second electrical interface, an optical communication channel optically connecting the source terminal and the sink terminal, and an auxiliary terminal. The optical communication channel may include a plurality of light-emitting diodes (LEDs). The source terminal and sink terminal may be configured to communicate with each other over the optical communication channel. In one aspect, the auxiliary terminal receives a power signal from an auxiliary signal source and transmits the power signal to the source terminal. The source terminal converts the power signal to a boosted power signal, and transmits the boosted power signal to the LEDs to illuminate the LEDs.

### RELATED APPLICATION

This application claims the priority benefit of U.S. Provisional Application Ser. No. 63/490,649, entitled “Light-emitting HDMI/DisplayPort Active Optical Cable,” filed May 16, 2023, the disclosure of which is incorporated by reference herein in its entirety.

### BACKGROUND

### Technical Field

The present disclosure relates to systems and methods that implement a light-emitting HDMI/DP active optical cable.

### Background Art

With the continuous development of information technology, high-definition audio and video signals are used in an increasing number of scenarios. As uncompressed high-definition video and multi-channel audio data can be transmitted with high quality and provide bandwidth supporting 1080p and higher resolutions, multimedia transmission cables, such as High-Definition Multimedia Interface (HDMI) active optical cables and DisplayPort (DP) active optical cables, are being widely used in various fields. However, existing HDMI/DP active optical cables are bulky and heavy, and only perform the function of transmitting signals without lighting effects. Especially at night or in low light, it can be difficult for a user to find the cable and distinguish the cable type if the user wishes to access the cable for any reason.

### SUMMARY

Aspects of the invention are directed to systems and methods for implementing a light-emitting HDMI/DP active optical cable (e.g., an optical connector).

One such optical connector includes a source terminal configured to electrically and mechanically connect to an electrical signal source via a first electrical interface. A sink terminal may be configured to electrically and mechanically connect to an electrical signal sink via a second electrical interface. The optical connector may include an optical communication channel optically connecting the source terminal and the sink terminal. The optical communication channel may include a plurality of light-emitting diodes (LEDs). The optical connector may also include an auxiliary terminal.

In one aspect, the source terminal receives one or more first electrical signals from the electrical signal source via the first electrical interface, converts the first electrical signals into corresponding optical signals, and transmits the optical signals to the sink terminal via the optical communication channel. The sink terminal may receive the optical signals, convert the optical signals into corresponding second electrical signals, and transmit the second electrical signals to the electrical signal sink.

In one aspect, the auxiliary terminal receives a power signal from an auxiliary signal source and transmits the power signal to the source terminal. The source terminal may convert the power signal to a boosted power signal, and transmit the boosted power signal to the LEDs to illuminate the LEDs.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a block diagram depicting an optical connector interface.

FIG. 2 is a schematic diagram depicting an optical connector.

FIG. 3 is a block diagram depicting a light-emitting regulation interface.

FIG. 4 is a block diagram depicting a light-emitting regulation interface.

FIGS. 5A and 5B are electrical interface diagrams depicting LED voltage regulation interfaces.

FIG. 6 is a schematic diagram depicting a cross-section of an optical cable.

FIG. 7 is a schematic diagram depicting a cross-section of an optical cable.

FIG. 8 is a three-dimensional schematic diagram of an optical cable.

FIG. 9 is a block diagram depicting an embodiment of a source terminal interface.

FIG. 10 is a block diagram depicting an embodiment of a sink terminal interface.

FIG. 11 is a block diagram depicting an embodiment of a source terminal interface.

FIG. 12 is a block diagram depicting an embodiment of a sink terminal interface.

### DETAILED DESCRIPTION

In the following description, reference is made to the accompanying drawings that form a part thereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random-access memory (RAM) device, a read-only memory (ROM) device, an erasable programmable read-only memory (EPROM or Flash memory) device, a portable compact disc read-only memory (CDROM), an optical storage device, a magnetic storage device, and any other storage medium now known or hereafter discovered. Computer program code for carrying out operations of the present disclosure may be written in any combination of one or more programming languages. Such code may be compiled from source code to computer-readable assembly language or machine code suitable for the device or computer on which the code can be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which includes one or more executable instructions for implementing the specified logical function(s). It is also noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

Aspects of the invention are directed to systems and methods for implementing a light-emitting HDMI/DP active optical cable. Such a cable may be comprised of a source terminal connectable to an electrical signal source, and a sink terminal connectable to an electrical signal sink. The source terminal and the sink terminal may be optically connected via a bidirectional optical communication channel. The source terminal may receive one or more source electrical signals form the electrical signal source, convert the source electrical signals to source optical signals, and transmit the source optical signals to the sink terminal via the optical communication channel. The sink terminal may receive the source optical signals, convert the source optical signals into receive source electrical signals, and transmit the receive source electrical signals to the electrical signal sink.

The sink terminal may receive one or more sink electrical signals from the electrical signal sink, convert the sink electrical signals to sink optical signals, and transmit the sink optical signals to the source terminal via the optical communication channel. The source terminal may receive the sink optical signals, convert the sink optical signals into receive sink electrical signals, and transmit the receive sink electrical signals to the electrical signal source.

The active optical cable may also include an auxiliary terminal that interfaces with an auxiliary signal source to supply power to the active optical cable. In one aspect, the supplied power is also used to illuminate one or more light-emitting diodes (LEDs) included in an optical cable assembly that includes the optical communication channel. These LEDs provide a luminescence effect to the active optical cable. This luminescence effect can be programmed and defined via the terminal device by users, including the brightness, color and timing, which can achieve a variety of static and dynamic luminescence types, performed by, for example, two light-emitting channels that are formed by the LEDs.

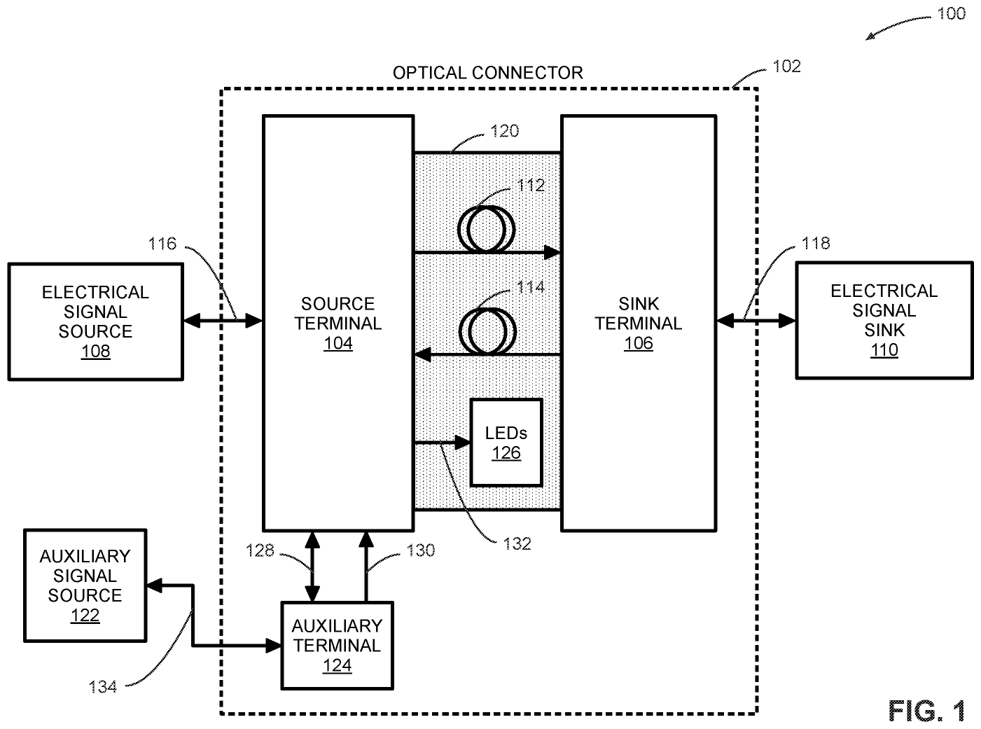

FIG. 1 is a block diagram depicting an optical connector interface 100. As depicted, optical connector interface 100 includes optical connector 102, electrical signal source 108, electrical signal sink 110, and auxiliary signal source 122. Optical connector 102 further includes source terminal 104, sink terminal 106, optical cable assembly 120, and auxiliary terminal 124. Optical cable assembly 120 further includes optical communication channels 112 and 114, LED interface 132, and LEDs 126. In one aspect, each of optical communication channel 112 and 114 is comprised of one or more optical fibers. Optical communication channel 112 is a unidirectional optical communication channel configured to transmit optical data from source terminal 104 to sink terminal 106. Optical communication channel 114 is a unidirectional optical communication channel configured to transmit optical data from sink terminal 104 to sink terminal 106.

In one aspect, electrical signal source 108 generates one or more source electrical signals to be transmitted to electrical signal sink 110. The source electrical signals may be received by source terminal 104 via source interface 116. Source interface 116 may implement an electrical and mechanical connection between electrical signal source 108 and source terminal 104. Source terminal 104 may convert the source electrical signals to source optical signals and transmit these source optical signals to sink terminal 106 via optical communication channel 112. Sink terminal 106 receives the source optical signals and converts the source optical signals into receive source electrical signals, which are then transmitted by sink terminal 106 to electrical signal sink 110 via sink interface 118.

In one aspect, optical connector 102 may be used to connect an audio-video signal source (electrical signal source 108) to an audio-video signal sink (electrical signal sink 110) using a supported digital audio-video communication protocol such as DVI, HDMI or DP. Examples of an audio-video signal source include a desktop computer, a laptop computer, a set top box, a video game console, a DVD player, a Blu Ray player, a VHS player, an Apple box, a PS5, an XBOX, a display card, a digital signal processor, and so on. Examples of an audio-video signal sinks include a video display monitor such as a liquid crystal display (LCD), an organic light emitting diode display (OLED), a cathode ray tube (CRT) display, an audio-video projector, and so on. Specific examples of an audio-video signal sink include a television and a computer display.

In one aspect, electrical signal sink 110 generates one or more sink electrical signals to be transmitted to electrical signal source 108. The sink electrical signals may be received by sink terminal 106 via sink interface 118. Sink interface 118 may implement an electrical and mechanical connection between electrical signal sink 110 and sink terminal 106. Sink terminal 106 may convert the sink electrical signals to sink optical signals and transmit these sink optical signals to source terminal 104 via optical communication channel 114. Source terminal 104 receives the sink optical signals and converts the sink optical signals into receive sink electrical signals, which are then transmitted by source terminal 104 to electrical signal source 108 via source interface 116. The sink electrical signals may be low-speed signals associated with the relevant digital audio-video communication protocol.

In one aspect, auxiliary terminal 124 is electrically and mechanically connected to auxiliary signal source 122 via auxiliary signal interface 134. Auxiliary signal interface 134 may be a bidirectional electrical signal interface such as a USB interface. Auxiliary terminal 124 may also be electrically and mechanically connected with source terminal 104 via data channel 128 and power channel 130.

In one aspect, auxiliary terminal 124 receives a power signal (e.g., a 5V USB power signal) from auxiliary signal source 122 via auxiliary signal interface 134. Auxiliary terminal 124 may route the power signal to source terminal 104 via power channel 130. Source terminal 104 may further route the power signal via LED interface 132 to LEDs 126, to illuminate LEDs 126.

In one aspect, auxiliary terminal receives one or more LED control signals from auxiliary signal source 122 via auxiliary signal interface 134. The LED control signals may be user-initiated to control the illumination of LEDs 126. For example, a user may wish to control a luminous intensity associated with LEDs 126, flash a pattern on LEDs 126, change one or more colors displayed by LEDs 126, etc. To achieve this, LEDs 126 may be any combination of monochromatic LEDs in different colors (e.g., red, blue, green, yellow, orange, etc.), or may be implemented using one or more tricolor LEDs. LEDs 126 may be arranged in specific patterns (e.g., a linear pattern) within optical cable assembly 120. LEDs 126 may be enclosed in a transparent outer layer of optical cable assembly 120. This transparent outer layer encapsulates LEDs 126 while allowing light generated by LEDs 126 to be transmitted outside of optical cable assembly 120.

The LED control signals may be routed by auxiliary terminal 124 to source terminal 104 via data channel 128. Source terminal 104 may further route the LED control signals to LEDs 126 via LED interface 132, to implement the desired user control functionality.

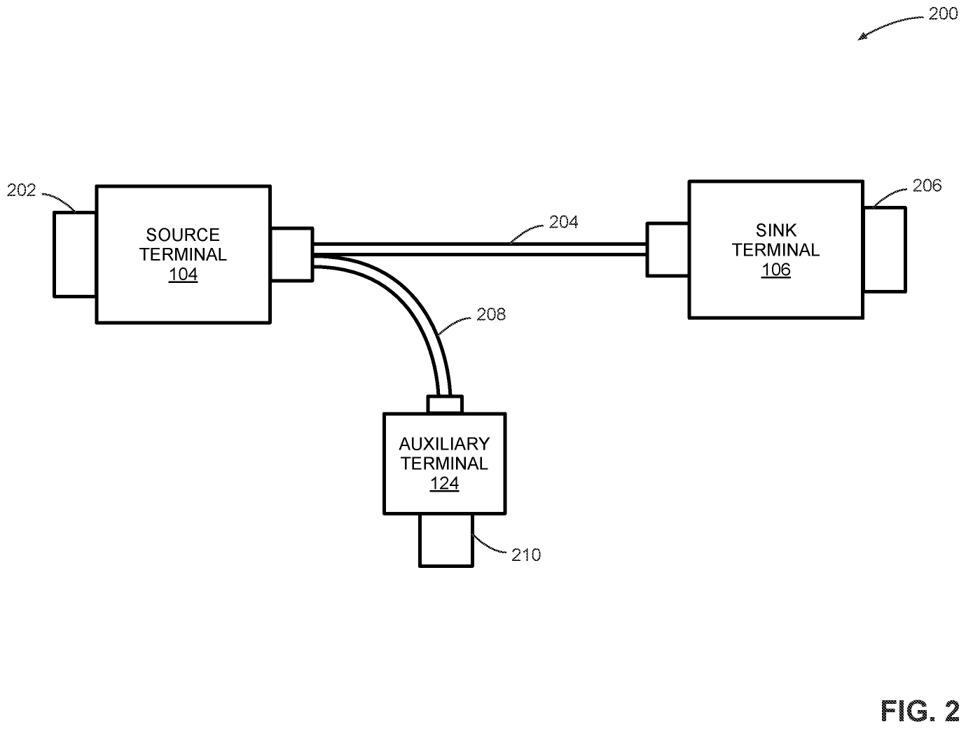

FIG. 2 is a schematic diagram depicting an optical connector 200. Optical connector 200 may be an embodiment of optical connector 102. As depicted, optical connector 200 includes source terminal 104, sink terminal 106, auxiliary terminal 124, optical cable assembly 204, auxiliary connector 208, source interface 202, and sink interface 206. In one aspect, optical cable assembly 204 is similar to optical cable assembly 120, and may include components identical or similar to optical communication channels 112 and 114, LED interface 132, and LEDs 126. Source interface 202 may be an electromechanical interface similar to source interface 116. Sink interface 206 may be an electromechanical interface similar to sink interface 118. Auxiliary interface 210 may be an electromechanical interface similar to auxiliary interface 134. Auxiliary connector 208 may be implemented as an electrical connector that includes both data channel 128 and power channel 130.

In a particular embodiment, optical connector 200 is configured to connect a source of digital audio-video data to a digital audio-video data sink. Examples of supported audio-video protocols include DVI, HDMI, and DP. Source interface 202 and sink interface 206 may be configured as electromechanical connectors consistent with the supported digital audio-video protocol. In a specific embodiment, auxiliary interface 210 is a USB interface that interfaces with auxiliary signal source 122 via a USB connection. Auxiliary interface 210 may support both USB power and USB data. The USB power may be used to power LEDs 126 and other aspects of optical connector 120. The USB data may be used to illuminate LEDs 126 using specific user commands (e.g., user configuration commands for LEDs 126).

In one aspect, LEDs 126 may be arranged or assembled as two light-emitting channels on either side of the communication channels 112 and 114. LEDs 126 may be comprised of a plurality of LED units, which may be evenly arranged at regular intervals or in a regular pattern along optical cable assembly 204. The luminescence effect of optical connector 200 can be programmed and defined via the auxiliary terminal 124 by users, including the brightness, color and timing, which can further achieve a variety of static and dynamic luminescence types, performed by the two light-emitting channels.

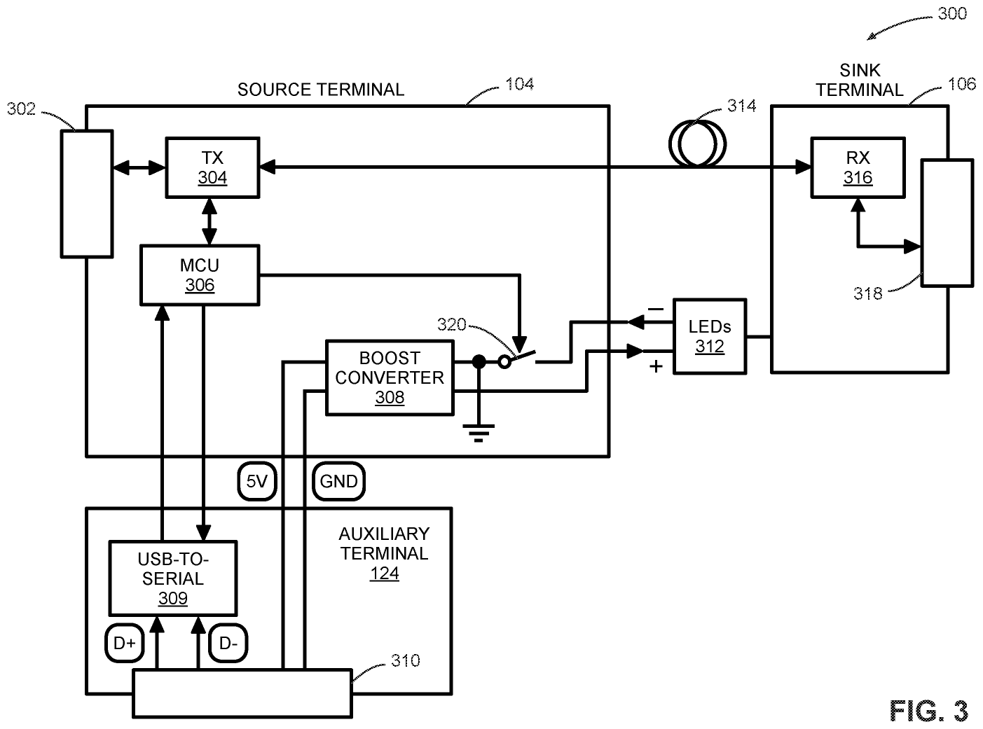

FIG. 3 is a block diagram depicting a light-emitting regulation interface 300. As depicted, light-emitting regulation interface 300 includes source terminal 104, sink terminal 106, auxiliary terminal 124, optical communication channel 314, and LEDs 312. Source terminal 104 further includes source interface 302, transmitter TX 304, microcontroller MCU 306, and boost converter 308. Sink terminal 106 further includes receiver RX 316, and sink interface 318. Auxiliary terminal 124 further includes USB-to-Serial converter 309, and auxiliary signal interface 310.

In one aspect, optical communication channel 314 is a bidirectional optical communication channel comprised of optical communication channels 112 and 114. LEDs 312 may be similar to LEDs 126. Source interface 302 may be similar to source interface 116. Sink interface 318 may be similar to sink interface 118. Auxiliary signal interface 310 may be similar to auxiliary signal interface 134.

In one aspect, TX 304 receives one or more source electrical signals (e.g., digital audio-video signals) from an electrical signal source (e.g., electrical signal source 108), via source interface 302. TX 304 may convert the source electrical signals into corresponding source optical signals and transmit the source optical signals via optical communication channel 314 to RX 316. RX 316 may convert the source optical signals into receive source electrical signals and transmit the receive source electrical signals to an electrical signal sink (e.g., electrical signal sink 110) via sink interface 318.

In one aspect, RX 316 receives one or more sink electrical signals (e.g., low-speed digital signals associated with an audio-video communication protocol such as HDMI) from an electrical signal sink (e.g., electrical signal sink 110), via sink interface 318. RX 316 may convert the sink electrical signals into corresponding sink optical signals and transmit the sink optical signals via optical communication channel 314 to TX 304. TX 304 may convert the sink optical signals into receive sink electrical signals and transmit the receive sink electrical signals to an electrical signal source (e.g., electrical signal source 108) via source interface 302.

In one aspect, auxiliary terminal 124 receives a 5V power signal (e.g., a 5V USB power signal) from an auxiliary signal source (e.g., auxiliary signal source 122, which can be a USB signal source), via auxiliary signal interface 310. Auxiliary terminal 124 routes the 5V power signal comprising a 5V signal and a ground signal to boost converter 308. Boost converter 308 may be configured to transmit the 5V power signal to LEDs 312 to illuminate the LEDs.

In one aspect, auxiliary terminal 124 receives one or more user configuration signals from an auxiliary signal source (e.g., auxiliary signal source 122), via auxiliary signal interface 310. These user configuration signals may be used to control different illumination properties of LEDs 312. In one aspect, the user configuration signals are received via a USB protocol, as D+ and D− signals. USB-to-serial 309 may be configured to decode the USB protocol, extract/decode the user configuration signals in a format that can be read by MCU 306, and send the decoded user configuration signals to MCU 306. Based on the decoded user configuration signals, MCU 306 controls boost converter 308 to control the illumination properties of LEDs 312 via switch 320.

In one aspect, the connection between MCU 306 and USB-to-serial 309, and from auxiliary signal interface 310 to boost converter 308 may be implemented via a combination of auxiliary terminal 124, auxiliary signal interface 310, and auxiliary cable 208.

Properties of LEDs 312 that can be controlled via the user configuration signals include:
Illumination (brightness)
Color
Time-varying illumination/patterns/colors

In one aspect, the power supply of the light-emitting channels (i.e., LEDs 312) is controlled by a boost converter circuit (i.e., boost converter 308). Auxiliary signal interface 310 may be a USB interface that is used for supplying power to the light-emitting channels. Boost converter 308 may be configured to regulate the input voltage of the light-emitting channels, connected to the anode of the LED units. A USB cable (e.g., auxiliary cable 208) can be used to route a 5V and a ground (GND) signal from the auxiliary signal interface 310, and deliver the 5V voltage to boost converter 308. The input voltage of the light-emitting channels is up-converted by boost converter 308 (e.g., 5V to 7V), to the operating voltage of the LED units in LEDs 312. Once the line is connected, the LED units light up.

In one aspect, the light of the light-emitting channels is regulated by MCU circuit 308. To accomplish this, auxiliary terminal 124 may receive one or more user-defined configuration signals associated with the light-emitting channels (i.e., LEDs 312), via auxiliary signal interface 310. This configuration information may be transmitted by D+ and D− signal transmission lines to USB-to-serial converter 309. USB-to-Serial port/converter 309 receives the D+ and D− signals, and generates a configuration signal which is transmitted to MCU (circuit) 306. MCU 306 may be controlled by the configuration signal, and may generate an LED control signal to determine whether to switch on switch 320. MCU 306 may also send back an acknowledgement signal USB-to-Serial converter 309. Switch 320 is directly controlled by the MCU 306, and is also connected to the cathode of the LED units. If switch 320 switched on, the cathode of the LED units (i.e., LEDs 312) will be connected to ground (GND), and the LED units will be turned on and light the light-emitting channels. If switch 320 is switched off, the cathode of the LED units will be disconnected, and the LED units will be turned off and cannot light the light-emitting channels. By continuously switching switch 320 on or off based on the user configuration signals, a variety of static and dynamic luminescence effects can be generated by MCU 306. In one aspect, LEDs 312 are implemented as two light-emitting channels. The two light-emitting channels can be configured independently, to achieve a variety of static and dynamic luminescence types. Techniques such as pulse-width modulation (PWM) can be implemented via MCU 306 to control the dynamic lighting of LEDs 312. As a result, the active optical cable presents the user-defined luminous effect. LEDs 312 may be mechanically connected to sink terminal 106, with no associated electrical connection.

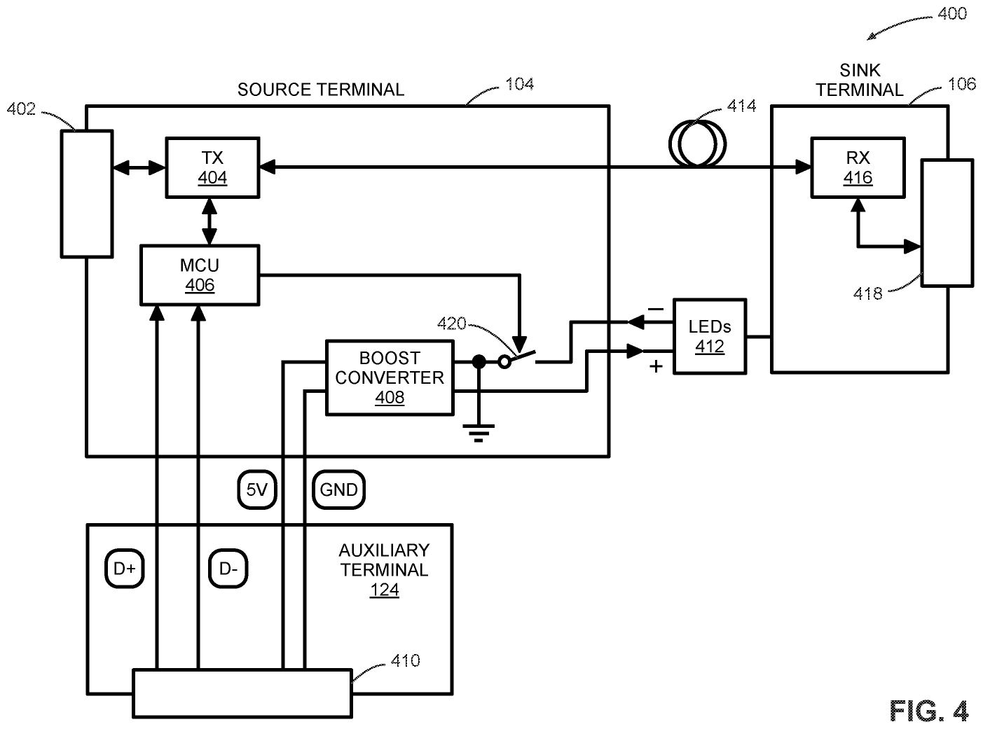

FIG. 4 is a block diagram depicting a light-emitting regulation interface 400. As depicted, light-emitting regulation interface 400 includes source terminal 104, sink terminal 106, auxiliary terminal 124, optical communication channel 414, and LEDs 412. Source terminal 104 further includes source interface 402, transmitter TX 404, microcontroller MCU 406, and boost converter 408. Sink terminal 106 further includes receiver RX 416, and sink interface 418. Auxiliary terminal 124 further includes auxiliary signal interface 410.

In one aspect, optical communication channel 414 is a bidirectional optical communication channel comprised of optical communication channels 112 and 114. LEDs 412 may be similar to LEDs 126. Source interface 402 may be similar to source interface 116. Sink interface 418 may be similar to sink interface 118. Auxiliary signal interface 410 may be similar to auxiliary signal interface 134.

In one aspect, TX 404 receives one or more source electrical signals (e.g., digital audio-video signals) from an electrical signal source (e.g., electrical signal source 108), via source interface 402. TX 404 may convert the source electrical signals into corresponding source optical signals and transmit the source optical signals via optical communication channel 414 to RX 416. RX 416 may convert the source optical signals into receive source electrical signals and transmit the receive source electrical signals to an electrical signal sink (e.g., electrical signal sink 110) via sink interface 418.

In one aspect, RX 416 receives one or more sink electrical signals (e.g., low-speed digital signals associated with an audio-video communication protocol such as HDMI) from an electrical signal sink (e.g., electrical signal source 110), via sink interface 418. RX 416 may convert the sink electrical signals into corresponding sink optical signals and transmit the sink optical signals via optical communication channel 414 to TX 404. TX 404 may convert the sink optical signals into receive sink electrical signals and transmit the receive sink electrical signals to an electrical signal source (e.g., electrical signal source 108) via source interface 402.

In one aspect, auxiliary terminal 124 receives a 5V power signal (e.g., a 5V USB power signal) from an auxiliary signal source (e.g., auxiliary signal source 122, which can be a USB signal source), via auxiliary signal interface 410. Auxiliary terminal 124 routes the 5V power signal comprising a 5V signal and a ground signal to boost converter 408. Boost converter 408 may be configured to transmit the 5V power signal to LEDs 412 to illuminate the LEDs.

In one aspect, auxiliary terminal 124 receives one or more user configuration signals from an auxiliary signal source (e.g., auxiliary signal source 122), via auxiliary signal interface 410. These user configuration signals may be used to control different illumination properties of LEDs 412. In one aspect, the user configuration signals are received via a USB protocol, as D+ and D− signals. MCU 406 may be configured to receive the D+ and D− signals, and retrieve the user configuration signals from the D+ and D− signals. Based on the user configuration signals, MCU 406 controls boost converter 408 to control the illumination properties of LEDs 412 via switch 420.

In one aspect, the connection between auxiliary signal interface 410 to MCU 406 and boost converter 408 may be implemented as via a combination of auxiliary terminal 124, auxiliary signal interface 210, and auxiliary cable 208.

Properties of LEDs 412 that can be controlled via the user configuration signals include:
Illumination (brightness)
Color
Time-varying illumination/patterns/colors

In one aspect, the power supply of the light-emitting channels (i.e., LEDs 412) is controlled by a boost converter circuit (i.e., boost converter 408). Auxiliary signal interface 410 may be a USB interface that is used for supplying power to the light-emitting channels. Boost converter 408 may be configured to regulate the input voltage of the light-emitting channels, connected to the anode of the LED units. A USB cable (e.g., auxiliary cable 208) can be used to route a 5V and a ground (GND) signal from the auxiliary signal interface 410, and deliver the 5V voltage to the boost converter 408. The input voltage of the light-emitting channels is up-converted by boost converter 408 (e.g., 5V to 7V), to the operating voltage of the LED units in LEDs 412. Once the line is connected, the LED units light up.

In one aspect, the light of the light-emitting channels is regulated by MCU circuit 406. To accomplish this, auxiliary terminal 124 may receive one or more user-defined configuration signals associated with the light-emitting channels (i.e., LEDs 412), via auxiliary signal interface 410. This configuration information may be transmitted by D+ and D− signal transmission lines to MCU (circuit) 406. MCU circuit 406 may be controlled by D+ and D− signals directly. MCU circuit 406 may generate a LED control signal to determine whether to switch on switch 420. Switch 420 may be directly controlled by the MCU 406, and is also connected to the cathode of the LED units. If switch 420 switched on, the cathode of the LED units (i.e., LEDs 412) will be connected to ground, and the LED units will be turned on and light the light-emitting channels. If switch 420 is switched off, the cathode of the LED units will be disconnected, and the LED units will be turned off and cannot light the light-emitting channels. By continuously switching switch 420 on or off based on the user configuration signals, a variety of static and dynamic luminescence effects can be generated by MCU 406.

In one aspect, LEDs 412 are implemented as two light-emitting channels. The two light-emitting channels can be configured independently, to achieve a variety of static and dynamic luminescence types. Techniques such as pulse-width modulation (PWM) can be implemented via MCU 406 to control the dynamic lighting of LEDs 412. As a result, the active optical cable presents the user-defined luminous effect.

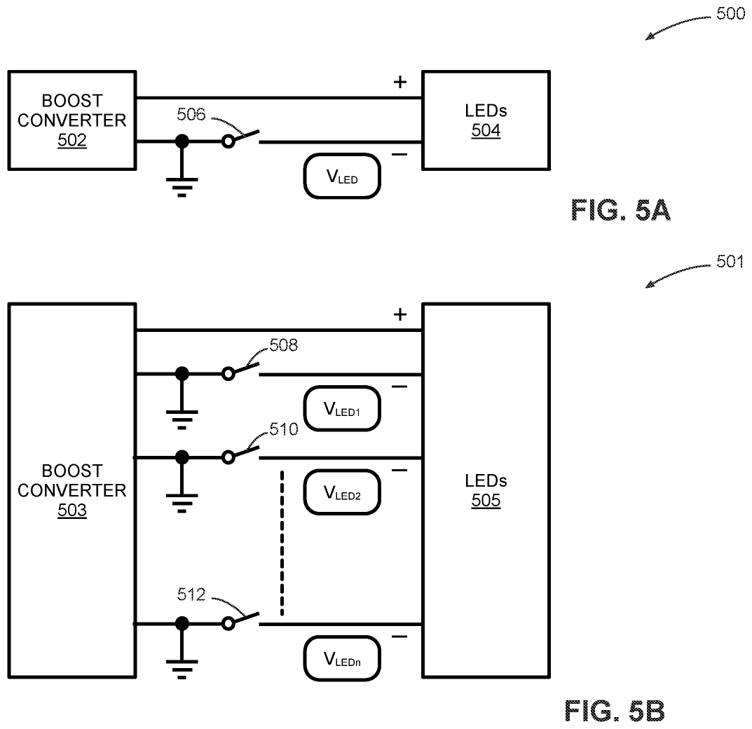

FIG. 5A is an electrical interface diagram depicting an LED voltage regulation interface 500. As depicted, LED voltage regulation interface 500 includes boost converter 502, LEDs 504, and switch 506. Boost converter 502 may be similar to boost converter 308 or 408. LEDs 504 may be similar to LEDs 312 or 412. Switch 506 may be similar to switch 320 or 420.

In one aspect, the voltage regulation of the light-emitting channels (i.e., LEDs 504) may be implemented by boost converter (circuit) 502 and switch 506. Switch 506 may be used to control the on and off switching of LEDs 504.

In one aspect, each of the light-emitting channels is comprised of a plurality of LED units (e.g., LEDs 504). In this embodiment, all the LED units are the same monochromatic LEDs. In one aspect, a USB cable (e.g., auxiliary connector 208) delivers a 5V and a GND signal from an associated electrical interface (e.g., auxiliary interface 134 or 210). However, a 5V input voltage may not be sufficient turn on (i.e., illuminate) all the LED units in the light-emitting channels. Hence, it is necessary to regulate the 5V voltage to the operating voltage of the LED units. To perform this voltage regulation, 5V signal and GND signal are transmitted to boost converter circuit 502 from USB electrical interface (i.e., auxiliary interface 134 or 210). Then, boost converter circuit 502 generates an up-converted output voltage that is approximately equal to an operating voltage of the LED units. For example, boost converter circuit may generate a voltage of approximately 7V, that may be sufficient to power and illuminate al LED units in the light-emitting channels (i.e., LEDs 504).

In one aspect, an anode of the LED units (i.e., LEDs 504) connected to the output of boost converter circuit 502. The cathode of the LED units connected to switch 506, and the cathode voltage is referred to as VLED. If switch 506 is switched on (i.e., closed), the cathode of the LED units (i.e., LEDs 504) will be connected to ground, and the LED units will be turned on and light the light-emitting channels. If switch 506 is switched off (i.e., open), the cathode of the LED units will be disconnected, and the LED units will be turned off and cannot light the light-emitting channels. Under microcontroller control (e.g., control by MCU 306 or 406), boost converter 502 may be used to turn switch 506 on and off to implement a pulse-width modulation scheme. This pulse-width modulation scheme can be used to control the illumination of LEDs 504 (as opposed to a simple on/maximum brightness and off switching scheme).

In an aspect, LED 504s are monochromatic LEDs. In other words, the LEDs in LEDs 504 all have the same color. In another embodiment, multicolor LEDs can be supported. In this case, a set of LEDs is divided into different subsets, with each subset including LEDs of the same color. FIG. 5B is an electrical interface diagram depicting an LED voltage regulation interface 501 for multicolor LEDs. As depicted, LED voltage regulation interface 501 includes boost converter 503, LEDs 505, and switches 508, 510, through 512. Boost converter 503 may be similar to boost converter 308 or 408. LEDs 505 may be similar to LEDs 312 or 412. Each of switches 508, 510, through 512 may be similar to switch 320 or 420.

In one aspect, the voltage regulation of the light-emitting channels (i.e., LEDs 505) may be implemented by boost converter (circuit) 503 and switches 508 through 512. Switches 508 through 512 may be used to control the on and off switching of LEDs 505. In one aspect, the number of switches may be equal to the number of sets of monochromatic LEDs.

In one aspect, each of the light-emitting channels is comprised of a plurality of LED units. In other words, LEDs 505 is comprised of n groups of monochromatic LEDs (n≥2). Each of switch 508 through 510 is connected to one group of monochromatic LEDs. These sets of monochromatic LEDs may be arranged in specific patterns in one or more light-emitting channels. In one aspect, a USB cable (e.g., auxiliary connector 208) delivers a 5V and a GND signal via electrical interface 210 or 134. In one aspect, this 5V input voltage cannot turn on the LED units (i.e., the LEDs in LEDs 505). Hence, it is necessary to regulate the 5V voltage to the operating voltage of the LED units.

In one aspect, the 5V signal and GND signal are transmitted to boost converter circuit 503 from a USB electrical interface (e.g., auxiliary interface 134).). Then, boost converter circuit 503 generates an up-converted output voltage that is approximately equal to an operating voltage of the LED units. For example, boost converter circuit may generate a voltage of approximately 7V, that may be sufficient to power and illuminate al LED units in the light-emitting channels (i.e., LEDs 505).

In one aspect, a common-anode of each LED in each set of monochromatic LEDs included in LEDs 505 is connected to an output of boost converter circuit 503. The cathodes of the different monochromatic LEDs are separately connected to switches 508, 510, through 512. The corresponding cathode voltages are referred as V_{LED1}, V_{LED2}, . . . , V_{LEDn}, respectively. If a switch (e.g., any of switch 508 through 512) is switched on, the cathode of the corresponding LED units will be connected to ground, then the corresponding LED units will be turned on. If that switch is switched off, the cathode of the corresponding LED units will be disconnected, and the corresponding LED units will be turned off. Switches 508 through 512 may be independently controlled by an MCU circuit (e.g., MCU 306 or 406). In this way, the on/off switching of the different monochromatic LEDs in LEDs 505 can be respectively controlled, to achieve color switching performance, including the brightness, color and timing.

In one aspect, a default control program may be stored in MCU 306 or 406, associated with source terminal 104. The default control program may be used to control LEDs 312 or 412 upon power-up. If a user wants to define a luminescence type associated with LEDs 312 or 412, a software in a USB host device (e.g., auxiliary signal source 122) connected to auxiliary terminal 124 via auxiliary signal interface 134 can also be used to control the LEDs, with the associated communication being performed between USB interface and the MCU (i.e., MCU 312 or 412).

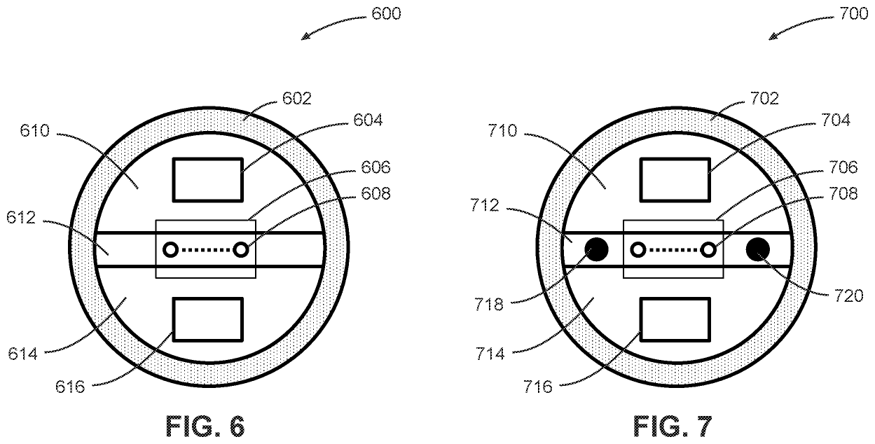

FIG. 6 is a schematic diagram depicting a cross-section of an optical cable 600. As depicted, optical cable 600 includes light-emitting channel 610, optical communication channel 612, light-emitting channel 614, coating layer 602, LED units 604 and 616, and optical fibers 606. Optical fibers 606 may be comprised of a plurality of optical fibers (e.g., optical fiber 608).

In one aspect, each of light-emitting channels 610 and 614 is a semicircular light-emitting channel. Each of light-emitting channels 610 and 614 may include LED units 604 and 616, respectively. Each of LED units 604 and 616 may include a plurality of LEDs, which may be evenly arranged in a specific pattern (e.g., linearly-arranged). LED units 604 and 616 may collectively be similar to LEDs 126, 312, 412, 504, or 505. The LED units can be the same monochromatic LEDs or a combination of different sets of monochromatic LEDs.

In one aspect, optical communication channel 612 includes optical fibers 606. Optical fibers 606 may include a plurality of optical fibers such as optical fiber 608. Optical communication channel may be similar to optical communication channels 314 or 414. In one aspect, the optical fibers included in optical fibers 606 may be assembled together in parallel. Optical communication channel 612 may be implemented as a bidirectional optical communication channel between a source terminal (e.g., source terminal 104) and a sink terminal (e.g., sink terminal 106). The number of optical fibers included in optical fibers 606 is not limited; any number of optical fibers that support a required bidirectional digital data transfer rate may be included in optical fibers 606.

In one aspect, coating layer 602 is able of light permeability, and is transparent to light emitted by LED units 604 and 606. This allows a user to observe the lighting effects generated by LED units 604 and 616. Coating layer 602 may be constructed to be tensile, to protect the cable from damage, and protect the cable from external pressure. The protection offered by coating layer 602 extends the usable life of cable, so that the cable is suitable for laying in various scenarios. Coating layer 602 can be constructed using nylon, polyester, spandex, acrylic fibers, or other material. In one aspect, the coating layer is a braided nylon material. Cross section 600 may be a cross section of optical cable assembly 204.

FIG. 7 is a schematic diagram depicting a cross-section of an optical cable 700. As depicted, optical cable 700 includes light-emitting channel 710, optical communication channel 712, light-emitting channel 714, coating layer 702, LED units 704 and 716, copper wires 718 and 720, and optical fibers 706. Optical fibers 706 may be comprised of a plurality of optical fibers (e.g., optical fiber 708).

In one aspect, each of light-emitting channels 710 and 714 is a semicircular light-emitting channel. Each of light-emitting channels 710 and 714 may include LED units 704 and 716, respectively. Each of LED units 704 and 716 may include a plurality of LEDs, which may be evenly arranged in a specific pattern (e.g., linearly-arranged). LED units 704 and 716 may collectively be similar to LEDs 126, 312, 412, 504, or 505. The LED units can be the same monochromatic LEDs or a combination of different sets of monochromatic LEDs.

In one aspect, optical communication channel 712, includes optical fibers 706. Optical fibers 706 may include a plurality of optical fibers such as optical fiber 708. Optical communication channel may be similar to optical communication channels 314 or 414. In one aspect, the optical fibers included in optical fibers 706 may be assembled together in parallel. Optical communication channel 712 may be implemented as a bidirectional optical communication channel between a source terminal (e.g., source terminal 104) and a sink terminal (e.g., sink terminal 106). The number of optical fibers included in optical fibers 706 is not limited; any number of optical fibers that support a required bidirectional digital data transfer rate may be included in optical fibers 606.

In one aspect, coating layer 702 is able of light permeability, and is transparent to light emitted by LED units 704 and 706. This allows a user to observe the lighting effects generated by LED units 704 and 716. Coating layer 702 may be constructed to be tensile, to protect the cable from damage, and protect the cable from external pressure. The protection offered by coating layer 702 extends the usable life of cable, so that the cable is suitable for laying in various scenarios. Coating layer 702 can be constructed using nylon, polyester, spandex, acrylic fibers, or other material. In one aspect, the coating layer is a braided nylon material. Cross section 700 may be a cross section of optical cable assembly 204.

In one aspect, copper wires 718 and 720 are copper conductors that transmit a +5V power supply signal for triggering between, for example, source terminal 104 and sink terminal 106. Copper wires (conductors) 718 and 720 may transmit a 5V triggering signal from electrical signal source 108 to electrical signal sink 110. To accomplish this, copper wire 718 may transmit the +5V power signal, and copper wire 720 may transmit a corresponding ground (GND) signal. (Optical cable assembly 120 is not shown to include such copper conductors as depicted in FIG. 1, but may include such copper conductors in other embodiments.) In general, optical cable assembly 120 includes one or more optical fibers (e.g., optical fibers 706 and one or more copper wires (e.g., copper wires 718 and 720).

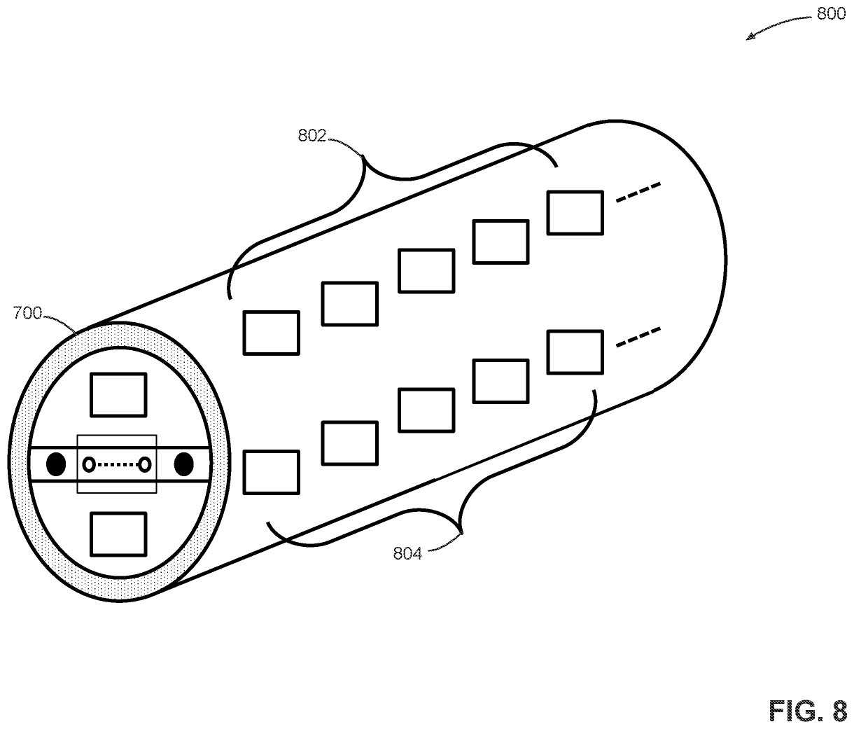

FIG. 8 is a three-dimensional schematic diagram 800 of optical cable 700. Schematic diagram 800 depicts light-emitting channels 804 and 806, arranged substantially parallel to an axis associated with optical cable 700. Essentially, light-emitting channels 804 and 806 are three-dimensional renditions of LED units 604 and 606, and LED units 704 and 706.

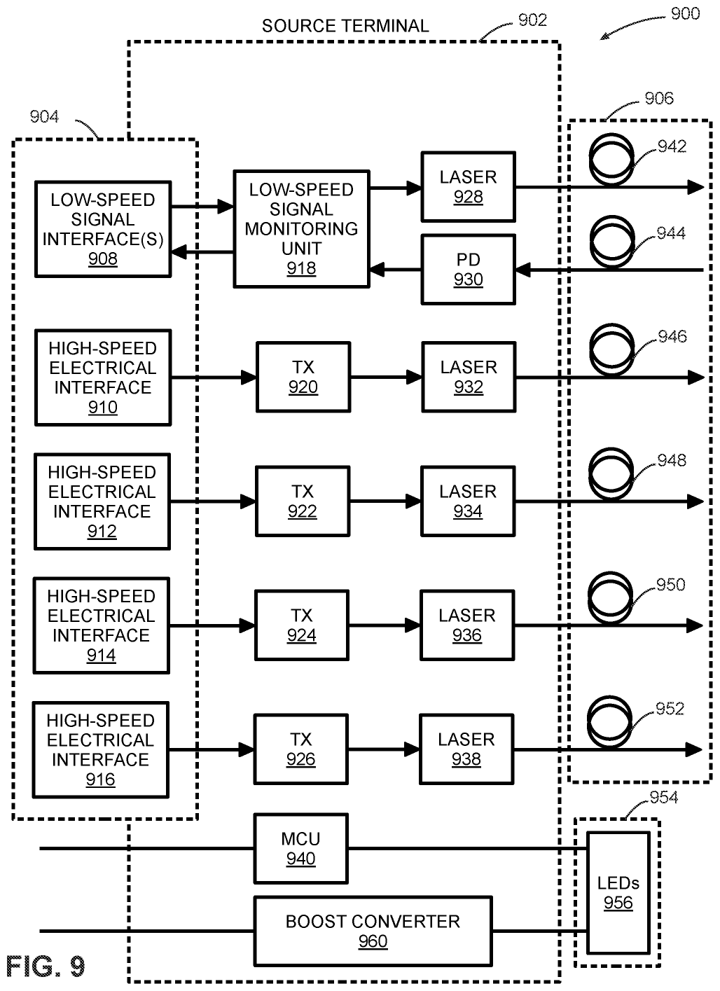

FIG. 9 is a block diagram depicting an embodiment of a source terminal interface 900. As depicted, source terminal interface 900 includes source interface 904, source terminal 902, optical communication channel 906, and light-emitting channel 954. Source interface 904 further includes low-speed signal interfaces 908, and high-speed electrical interfaces 910, 912, 914, and 916. Source terminal 902 further includes low-speed signal monitoring unit 918, transmit units TX 920, 922, 924, and 926, lasers 928, 932, 934, 936 and 938, photodetector PD 930, microcontroller unit/circuit 940, and boost converter circuit 960. Optical communication channel 906 further includes optical fibers 942, 944, 946, 948, 950, and 952. Each of optical fibers 942, 944, 946, 948, 950, and 952 may be comprised of a single optical fiber, or a bundle of two or more optical fibers. Light-emitting channel 954 further includes LEDs 956. In one aspect, source terminal 902 and all associated components are integrated onto a printed circuit board.

In one aspect, source interface 904 is similar to source interface 116. Source terminal 902 may be viewed as a source terminal similar to source terminal 104, integrated on a printed circuit board. Optical communication channel 906 and light-emitting channel 954 may be integrated into optical cable assembly 120. Optical communication channel 906 may be similar to optical communication channels 112 and 114 with respect to functionality. Light-emitting channel 954 may be similar to LED interface 132 and LEDs 126. Lasers 928, 932, 934, 936 and 938 may be implemented as laser diodes, vertical-cavity surface-emitting lasers (VCSELs), or as any other kind of integrated laser source.

In one aspect, low-speed signal monitoring unit 918 receives one or more source low-speed electrical signals associated with a specific digital communication protocol (e.g., an HDMI or DP communication protocol), from an electrical signal source such as electrical signal source 108. These source low-speed electrical signals may be received by low-speed signal monitoring unit 918 via low-speed signal interfaces 908. Low-speed signal monitoring unit 918 may condition these source low-speed electrical signals and transmit the conditioned source low-speed electrical signals to laser 928. Laser 928 may convert the conditioned source low-speed electrical signals to source low-speed optical signals, and transmit the source low-speed optical signals to a sink terminal such as sink terminal 106, via optical fiber 942.

In an aspect, photodetector PD 930 receives one or more sink low-speed optical signals from a sink terminal (e.g., sink terminal 106) via optical fiber 944. These sink low-speed optical signals may be associated with the digital communication protocol supported by the source low-speed electrical signals. PD 930 may convert the sink low-speed optical signals into receive sink low-speed electrical signals, and transmit the receive sink low-speed electrical signals to low-speed signal monitoring unit 918. Low-speed signal monitoring unit 918 may condition the receive sink low-speed electrical signals and transmit the conditioned receive sink low-speed electrical signals to, for example, electrical signal source 102, via low-speed signal interfaces 908.

In one aspect, each of TX 920 through 926 is similar to TX 304 or TX 404. Each of TX 920, 922, 924, and 926 receives a separate source high-speed electrical signal from high-speed electrical interfaces 910, 912, 914, and 916, respectively. These high-speed electrical signals may be associated with the digital communication protocol supported by the source and sink low-speed electrical signals. In one aspect, each of TX 920, 922, 924, and 926 conditions the respective source high-speed electrical signal, and transmits the conditioned source high-speed electrical signal to lasers 932, 934, 936, and 938, respectively. Each of laser 932, 934, 936, and 938 converts the corresponding conditioned source high-speed electrical signal into a source high-speed optical signal, and transmits the respective source high-speed optical signal to a sink terminal (e.g., sink terminal 106) via optical fibers 946, 948, 950, and 952, respectively.

In one aspect, boost converter 960 may be similar to boost converter 308 or 408. Boost converter 960 may be configured to convert an input 5V power signal to a higher voltage signal (e.g., 7V) to drive LEDs 956 in light-emitting channel 954. MCU 940 may be similar to MCU 306 or 406. MCU 940 may be configured to control boost converter 960 to further control the illumination properties of LEDs 956.

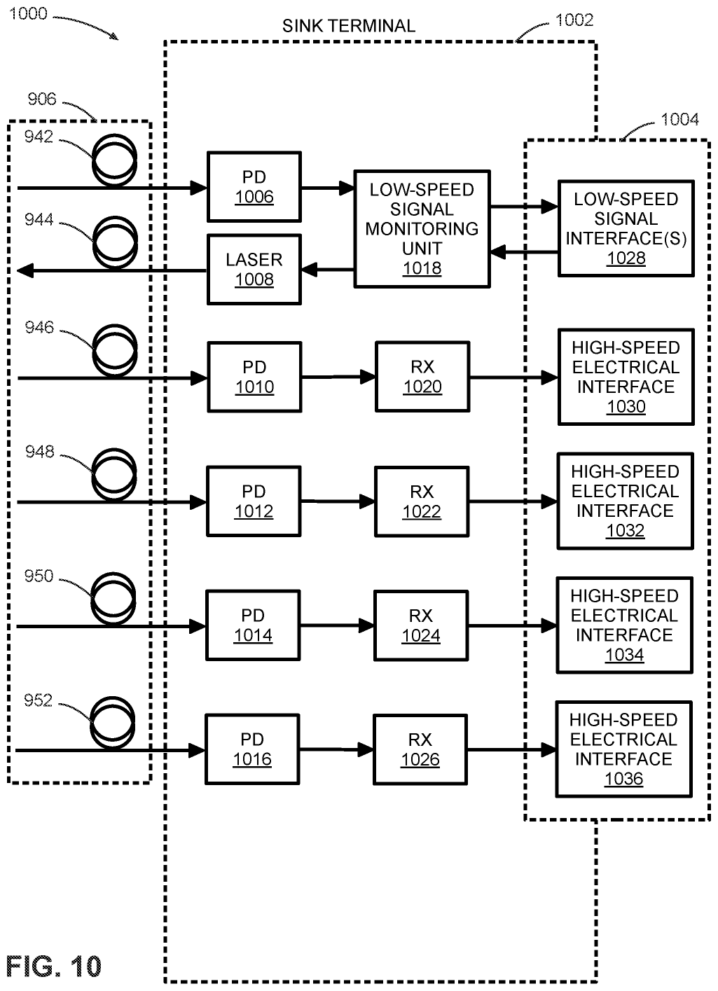

FIG. 10 is a block diagram depicting an embodiment of a sink terminal interface 1000. As depicted, sink terminal interface 1000 includes sink interface 1004, printed circuit board sink terminal 1002, and optical communication channel 906. Sink interface 1004 further includes low-speed signal interfaces 1028, and high-speed electrical interfaces 1030, 1032, 1034, and 1036. Sink terminal 1002 further includes low-speed signal monitoring unit 1018, receive units RX 1020, 1022, 1024, and 1026, photodetectors PD 1006, 1010, 1012, 1014 and 1016, and laser 1008. Optical communication channel 906 further includes optical fibers 942, 944, 946, 948, 950, and 952. Each of optical fibers 942, 944, 946, 948, 950, and 952 may be comprised of a single optical fiber, or a bundle of two or more optical fibers. In one aspect, sink terminal 1002 and all associated components are integrated onto a printed circuit board.

In one aspect, sink interface 1004 is similar to sink interface 118. Sink terminal 1002 may be viewed as a sink terminal similar to sink terminal 106, integrated on a printed circuit board. Optical communication channel 906 and light-emitting channel 954 may be integrated into optical cable assembly 120. Optical communication channel 906 may be similar to optical communication channels 112 and 114 with respect to functionality. Laser 1008 may be implemented as a laser diode, a vertical-cavity surface-emitting laser (VCSEL), or as any other kind of integrated laser source.

In one aspect, low-speed signal monitoring unit 1018 receives one or more sink low-speed electrical signals associated with a specific digital communication protocol (e.g., an HDMI or DP communication protocol), from an electrical signal sink such as electrical signal sink 110. These sink low-speed electrical signals may be received by low-speed signal monitoring unit 1018 via low-speed signal interfaces 1028. Low-speed signal monitoring unit 1018 may condition these sink low-speed electrical signals and transmit the conditioned sink low-speed electrical signals to laser 1008. Laser 1008 may convert the conditioned sink low-speed electrical signals to sink low-speed optical signals, and transmit the sink low-speed optical signals to a source terminal such as source terminal 104, via optical fiber 944.

In an aspect, photodetector PD 1006 receives one or more source low-speed optical signals from a source terminal (e.g., source terminal 104) via optical fiber 942. These source low-speed optical signals may be associated with the digital communication protocol supported by the sink low-speed electrical signals. PD 1006 may convert the source low-speed optical signals into receive source low-speed electrical signals, and transmit the receive source low-speed electrical signals to low-speed signal monitoring unit 1018. Low-speed signal monitoring unit 1018 may condition the receive source low-speed electrical signals and transmit the conditioned receive source low-speed electrical signals to, for example, electrical signal sink 110, via low-speed signal interfaces 1028.

In one aspect, each of RX 1020 through 1026 is similar to RX 316 or RX 416. Each of PD 1010, 1012, 1014 and 1016 receives a separate source high-speed optical signal via optical fibers 946, 948, 950, and 952, respectively. Each of PD 1010, 1012, 1014 and 1016 may convert the corresponding source high-speed optical signal into a receive source high-speed electrical signal, and transmit the corresponding receive source high-speed electrical signal to each of RX 1020, 1022, 1024 and 1026, respectively. Each of RX 1020, 1022, 1024 and 1026 may condition the respective receive source high-speed electrical signals and transmit the conditioned receive source high-speed electrical signals to an electrical signal sink (e.g., electrical signal sink 110) via high-speed electrical interfaces 1030, 1032, 1034, and 1036, respectively.

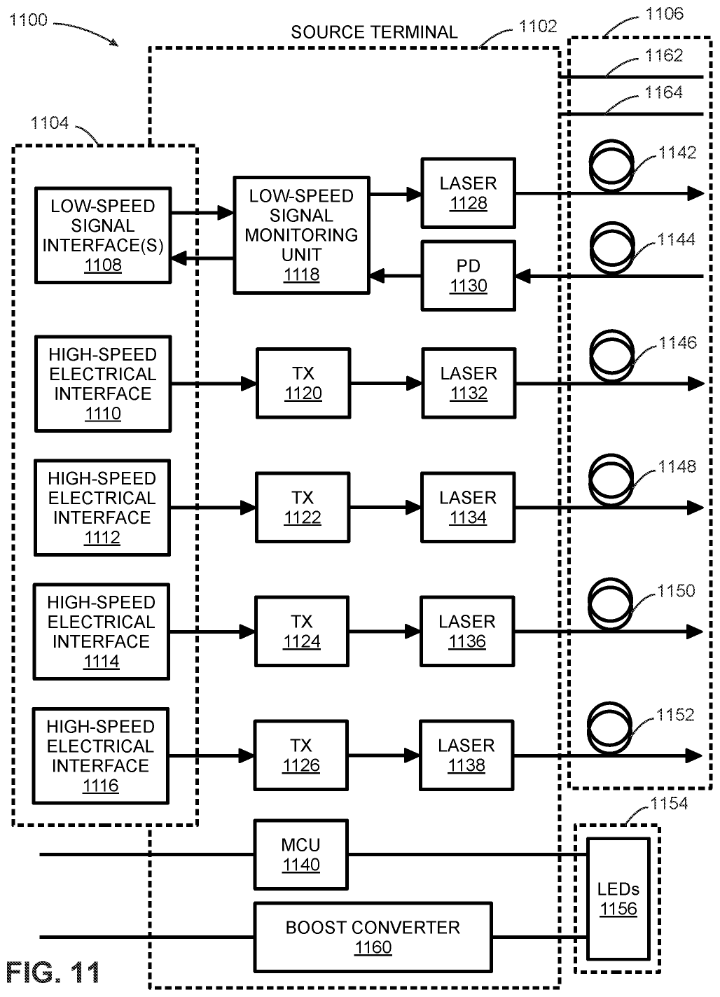

FIG. 11 is a block diagram depicting an embodiment of a source terminal interface 1100. As depicted, source terminal interface 1100 includes source interface 1104, printed circuit board source terminal 1102, optical communication channel 1106, and light-emitting channel 1154. Source interface 1104 further includes low-speed signal interfaces 1108, and high-speed electrical interfaces 1110, 1112, 1114, and 1116. Source terminal 1102 further includes low-speed signal monitoring unit 1118, transmit units TX 1120, 1122, 1124, and 1126, lasers 1128, 1132, 1134, 1136 and 1138, photodetector PD 1130, microcontroller unit/circuit 1140, and boost converter circuit 160. Optical communication channel 1106 further includes optical fibers 1142, 1144, 1146, 1148, 1150, and 1152, 5V copper wire 1162, and ground (GND) copper wire 1164. Each of optical fibers 1142, 1144, 1146, 1148, 1150, and 1152 may be comprised of a single optical fiber, or a bundle of two or more optical fibers. Light-emitting channel 1154 further includes LEDs 1156. In one aspect, source terminal 1102 and all associated components are integrated onto a printed circuit board.

In one aspect, source interface 1104 is similar to source interface 116. Source terminal 1102 may be viewed as a source terminal similar to source terminal 104, integrated on a printed circuit board. Optical communication channel 1106 and light-emitting channel 1154 may be integrated into optical cable assembly 120. Optical communication channel 1106 may be similar to optical communication channels 112 and 114 with respect to functionality. Light-emitting channel 1154 may be similar to LED interface 132 and LEDs 126. Lasers 1128, 1132, 1134, 1136 and 1138 may be implemented as laser diodes, vertical-cavity surface-emitting lasers (VCSELs), or as any other kind of integrated laser source.

In one aspect, low-speed signal monitoring unit 1118 receives one or more source low-speed electrical signals associated with a specific digital communication protocol (e.g., an HDMI or DP communication protocol), from an electrical signal source such as electrical signal source 108. These source low-speed electrical signals may be received by low-speed signal monitoring unit 1118 via low-speed signal interfaces 1108. Low-speed signal monitoring unit 1118 may condition these source low-speed electrical signals and transmit the conditioned source low-speed electrical signals to laser 1128. Laser 1128 may convert the conditioned source low-speed electrical signals to source low-speed optical signals, and transmit the source low-speed optical signals to a sink terminal such as sink terminal 106, via optical fiber 1142.

In an aspect, photodetector PD 1130 receives one or more sink low-speed optical signals from a sink terminal (e.g., sink terminal 106) via optical fiber 1144. These sink low-speed optical signals may be associated with the digital communication protocol supported by the source low-speed electrical signals. PD 1130 may convert the sink low-speed optical signals into receive sink low-speed electrical signals, and transmit the receive sink low-speed electrical signals to low-speed signal monitoring unit 1118. Low-speed signal monitoring unit 1118 may condition the receive sink low-speed electrical signals and transmit the conditioned receive sink low-speed electrical signals to, for example, electrical signal source 102, via low-speed signal interfaces 1108.

In one aspect, each of TX 1120 through 1126 is similar to TX 304 or TX 404. Each of TX 1120, 1122, 1124, and 1126 receives a separate source high-speed electrical signal from high-speed electrical interfaces 1110, 1112, 1114, and 1116, respectively. These high-speed electrical signals may be associated with the digital communication protocol supported by the source and sink low-speed electrical signals. In one aspect, each of TX 1120, 1122, 1124, and 1126 conditions the respective source high-speed electrical signal, and transmits the conditioned source high-speed electrical signal to lasers 1132, 1134, 1136, and 1138, respectively. Each of laser 1132, 1134, 1136, and 1138 converts the corresponding conditioned source high-speed electrical signal into a source high-speed optical signal, and transmits the respective source high-speed optical signal to a sink terminal (e.g., sink terminal 106) via optical fibers 1146, 1148, 1150, and 1152, respectively.

In one aspect, boost converter 1160 may be similar to boost converter 308 or 408. Boost converter 1160 may be configured to convert an input 5V power signal to a higher voltage signal (e.g., 7V) to drive LEDs 1156 in light-emitting channel 1154. MCU 1140 may be similar to MCU 306 or 406. MCU 1140 may be configured to control boost converter 1160 to further control the illumination properties of LEDs 1156.

In one aspect, the pair of copper wires (conductors) formed by 5V copper wire 1162, and ground (GND) copper wire 1164 are used to supply a 5V triggering signal from electrical signal source 108 to electrical signal sink 110. Such triggering signals may be used for triggering electrical signal sinks that communicate with an HDMI or a DP protocol.

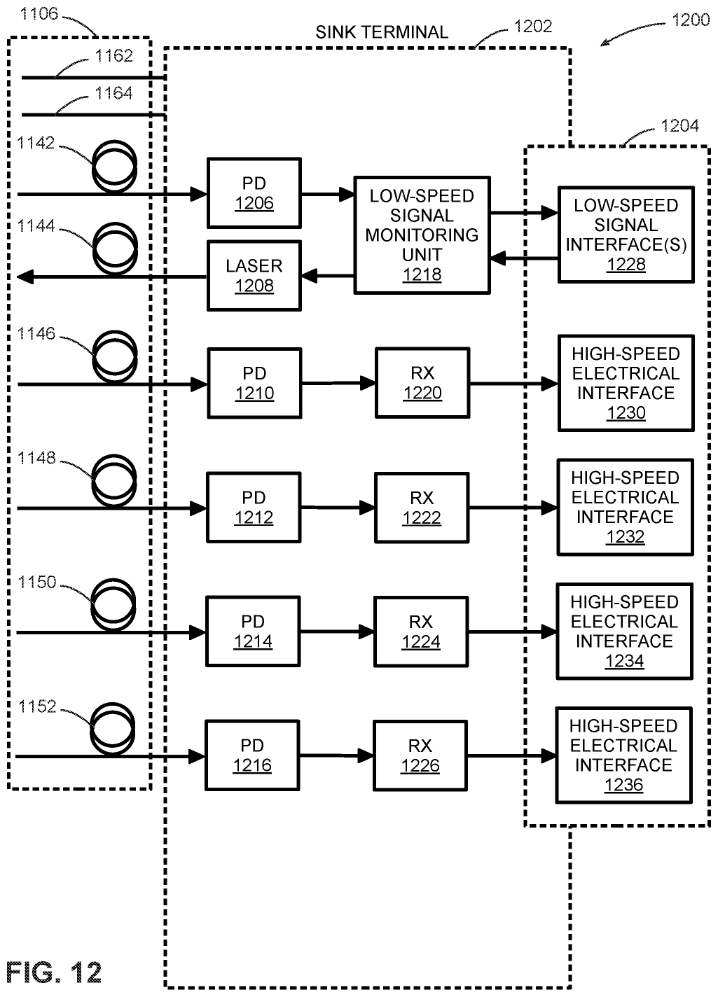

FIG. 12 is a block diagram depicting an embodiment of a sink terminal interface 1200. As depicted, sink terminal interface 1200 includes sink interface 1204, printed circuit board Sink terminal 1202, and optical communication channel 1106. Sink interface 1204 further includes low-speed signal interfaces 1228, and high-speed electrical interfaces 1230, 1232, 1234, and 1236. Sink terminal 1202 further includes low-speed signal monitoring unit 1218, receive units RX 1220, 1222, 1224, and 1226, photodetectors PD 1206, 1210, 1212, 1214 and 1216, and laser 1208 Optical communication channel 1206 further includes optical fibers 1142, 1144, 1146, 1148, 1150, and 1152, 5V copper wire 1162, and ground (GND) copper wire 1164. Each of optical fibers 1142, 1144, 1146, 1148, 1150, and 1152 may be comprised of a single optical fiber, or a bundle of two or more optical fibers. In one aspect, sink terminal 1202 and all associated components are integrated onto a printed circuit board.

In one aspect, sink interface 1204 is similar to sink interface 118. Sink terminal 1202 may be viewed as a sink terminal similar to sink terminal 106, integrated on a printed circuit board. Optical communication channel 1106 and light-emitting channel 1154 may be integrated into optical cable assembly 120. Optical communication channel 1106 may be similar to optical communication channels 112 and 114 with respect to functionality. Laser 1208 may be implemented as a laser diode, a vertical-cavity surface-emitting laser (VCSEL), or as any other kind of integrated laser source.

In one aspect, low-speed signal monitoring unit 1218 receives one or more sink low-speed electrical signals associated with a specific digital communication protocol (e.g., an HDMI or DP communication protocol), from an electrical signal sink such as electrical signal sink 110. These sink low-speed electrical signals may be received by low-speed signal monitoring unit 1218 via low-speed signal interfaces 1228. Low-speed signal monitoring unit 1218 may condition these sink low-speed electrical signals and transmit the conditioned sink low-speed electrical signals to laser 1208. Laser 1208 may convert the conditioned sink low-speed electrical signals to sink low-speed optical signals, and transmit the sink low-speed optical signals to a source terminal such as source terminal 104, via optical fiber 1144.

In an aspect, photodetector PD 1206 receives one or more source low-speed optical signals from a source terminal (e.g., source terminal 104) via optical fiber 1142. These source low-speed optical signals may be associated with the digital communication protocol supported by the sink low-speed electrical signals. PD 1206 may convert the source low-speed optical signals into receive source low-speed electrical signals, and transmit the receive source low-speed electrical signals to low-speed signal monitoring unit 1218. Low-speed signal monitoring unit 1218 may condition the receive source low-speed electrical signals and transmit the conditioned receive source low-speed electrical signals to, for example, electrical signal sink 110, via low-speed signal interfaces 1228.

In one aspect, each of RX 1220 through 1226 is similar to RX 316 or RX 416. Each of PD 1210, 1212, 1214 and 1216 receives a separate source high-speed optical signal via optical fibers 1146, 1148, 1150, and 1152, respectively. Each of PD 1210, 1212, 1214 and 1216 may convert the corresponding source high-speed optical signal into a receive source high-speed electrical signal, and transmit the corresponding receive source high-speed electrical signal to each of RX 1220, 1222, 1224 and 1226, respectively. Each of RX 1220, 1222, 1224 and 1226 may condition the respective receive source high-speed electrical signals and transmit the conditioned receive source high-speed electrical signals to an electrical signal sink (e.g., electrical signal sink 110) via high-speed electrical interfaces 1230, 1232, 1234, and 1236, respectively.

Although the present disclosure is described in terms of certain example embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the scope of the present disclosure.

What is claimed is:

1. An optical connector comprising:
a source terminal configured to electrically and mechanically connect to an electrical signal source via a first electrical interface;
a sink terminal configured to electrically and mechanically connect to an electrical signal sink via a second electrical interface;
an optical communication channel optically connecting the source terminal and the sink terminal, wherein the optical communication channel includes a plurality of light-emitting diodes (LEDs); and
an auxiliary terminal, wherein:
the source terminal receives one or more source electrical signals from the electrical signal source via the first electrical interface, converts the source electrical signals into corresponding source optical signals, and transmits the source optical signals to the sink terminal via the optical communication channel;
the sink terminal receives the source optical signals, converts the source optical signals into corresponding receive source electrical signals, and transmits the receive source electrical signals to the electrical signal sink via the second electrical interface; and
the auxiliary terminal receives a power signal from an auxiliary signal source and transmits the power signal to the source terminal, and wherein the source terminal converts the power signal to a boosted power signal, and transmits the boosted power signal to the LEDs to illuminate the LEDs.

2. The optical connector of claim 1, wherein the source terminal includes a boost converter configured to convert the power signal to the boosted power signal.

3. The optical connector of claim 1, wherein the optical communication channel includes one or more optical fibers configured to transmit the optical signals.

4. The optical connector of claim 1, wherein the LEDs are monochromatic LEDs of a single color.

5. The optical connector of claim 1, wherein the LEDs are monochromatic LEDs of different colors.

6. The optical connector of claim 1, further comprising a microcontroller configured to:
receive one or more user inputs to control an illumination of individual LEDs; and
control the illumination via a switch based on the user inputs.

7. The optical connector of claim 6, wherein the auxiliary terminal receives the user inputs from a user and transmits the user inputs to the microcontroller.

8. The optical connector of claim 1, wherein the electrical signals are associated with any of an HDMI protocol or a DP protocol.

9. The optical connector of claim 1, wherein:
the sink terminal receives one or more sink electrical signals from the electrical signal sink via the second electrical interface, converts the sink electrical signals into corresponding sink optical signals, and transmits the sink optical signals to the source terminal via the optical communication channel; and
the source terminal receives the sink optical signals, converts the sink optical signals into corresponding receive sink electrical signals, and transmits the receive sink electrical signals to the electrical signal source via the first electrical interface.

10. The optical connector of claim 1, further comprising a pair of copper conductors connecting the source terminal and sink terminal, wherein the pair of copper conductors conducts a 5V triggering voltage from the electrical signal source to the electrical signal sink via the source terminal and the sink terminal.

11. A method comprising:
a source terminal receiving one or more source electrical signals from an electrical signal source via a first electrical interface;
the source terminal converting the source electrical signals into corresponding source optical signals;
the source terminal transmitting the source optical signals to a sink terminal via an optical communication channel;
the sink terminal receiving the source optical signals;
the sink terminal converting the source optical signals into corresponding receive source electrical signals;
the sink terminal transmitting the receive source electrical signals to an electrical signal sink via a second electrical interface;
an auxiliary terminal receiving a power signal from an auxiliary signal source;
the auxiliary terminal transmitting the power signal to the source terminal;
the source terminal converting the power signal to a boosted power signal; and
the source terminal transmitting the boosted power signal to a plurality of LEDs to illuminate the LEDs.

12. The method of claim 11, wherein the source terminal includes a boost converter configured to convert the power signal to the boosted power signal.

13. The method of claim 11, wherein the optical communication channel includes one or more optical fibers configured to transmit the optical signals.

14. The method of claim 11, wherein the LEDs are monochromatic LEDs of a single color.

15. The method of claim 11, wherein the LEDs are monochromatic LEDs of different colors.

16. The method of claim 11, further comprising:
a microcontroller receiving one or more user inputs to control an illumination of individual LEDs; and
the microcontroller controlling the illumination via a switch based on the user inputs.

17. The method of claim 16, further comprising:
the auxiliary terminal receiving the user inputs from a user; and
the auxiliary terminal transmitting the user inputs to the microcontroller.

18. The method of claim 11, wherein the electrical signals are associated with any of an HDMI protocol or a DP protocol.

19. The method of claim 11, further comprising:
the sink terminal receiving one or more sink electrical signals from the electrical signal sink via the second electrical interface;
the sink terminal converting the sink electrical signals into corresponding sink optical signals;
the sink terminal transmitting the sink optical signals to the source terminal via the optical communication channel;
the source terminal receiving the sink optical signals;
the source terminal converting the sink optical signals into corresponding receive sink electrical signals; and
the source terminal transmitting the receive sink electrical signals to the electrical signal source via the first electrical interface.

20. The method of claim 11, further comprising a pair of copper conductors connecting the source terminal and sink terminal, wherein the pair of copper conductors conducts a 5V triggering voltage from the electrical signal source to the electrical signal sink via the source terminal and the sink terminal.
